(19) United States
(12) Patent Application Publication
(10) Pub. No.: US 2019/0045699 A1
(43) Pub. Date: Feb. 14, 2019

(54) GARDENING APPARATUS AND METHOD

(71) Applicant: Pedro Dominguez Moreno, Kannapolis, NC (US)

(72) Inventor: Pedro Dominguez Moreno, Kannapolis, NC (US)

(21) Appl. No.: 15/946,330

(22) Filed: Apr. 5, 2018

Related U.S. Application Data
(60) Provisional application No. 62/543,330, filed on Aug. 9, 2017.

(51) Int. Cl. A01B 49/06; A01B 45/02; A01C 17/00

(52) U.S. Cl. CPC A01B 49/06; A01C 17/001; A01B 45/02

(57) ABSTRACT

A gardening apparatus including a housing having an inner chamber, a handle, a hose coupled to the handle and configured to actuate release of a granular substance, a receiving clip, a plurality of wheels, a rotatable structure, and a plurality of circular devices including a plurality of projections, wherein the plurality of circular devices is removably attached to the plurality of wheels. The gardening apparatus is useful for simultaneously fertilizing and aerating a lawn or garden, while promoting speedy germination of plants, flowers, vegetables, and more.

### CROSS-REFERENCE TO RELATED APPLICATION(S)

The present application is related to and claims priority to U.S. Provisional Patent Application No. 62/543,330 filed Aug. 9, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of gardening devices of existing art and more specifically relates to fertilizer and aerating tools.

### Related Art

Planting flowers, vegetables, and other plants can be a difficult process. Soil must be aerated properly to ensure optimal growth. Some people may get frustrated if soil cannot be properly maintained. Air exchange if not aerated is inefficient, leading to poor plant growth. Many devices exist for helping a user to either aerate or fertilize their lawns, but these devices are often expensive or inefficient in practice. A suitable solution is desired.

U.S. Pat. No. 5,769,169 to Frank Miksitz relates to a soil irrigation and aeration apparatus. The described soil irrigation and aeration apparatus includes an irrigation and aeration device that includes a drum having a plurality of probes for penetrating the ground and injecting water into the soil. The probes are made from stainless steel spring pins having an elongated slot and an open outer end. The drum includes a plurality of compartments for receiving water from a supply and a valve assembly for selectively dispensing the water to the compartments. The valve assembly can be actuated by a foot contacting the ground, a valve actuated by rotation of the drum, or a solenoid actuated valve.

### SUMMARY OF THE INVENTION

In view of the foregoing disadvantages inherent in the known gardening devices art, the present disclosure provides a novel gardening apparatus. The general purpose of the present disclosure, which will be described subsequently in greater detail, is to provide a gardening and agricultural tool capable of simultaneously fertilizing and aerating a lawn or garden, while promoting speedy germination of plants, flowers, vegetables, and more.

A gardening apparatus is disclosed herein. The gardening apparatus may include a housing having an inner chamber, a handle, a hose coupled to the handle and configured to actuate release of a granular substance, a receiving clip, a plurality of wheels, a rotatable structure, and a plurality of circular devices including a plurality of projections, wherein the plurality of circular devices may be removably attached to the plurality of wheels.

According to another embodiment, a method of simultaneously aerating and fertilizing soil is also disclosed herein. The method of simultaneously aerating and fertilizing soil includes providing an apparatus for gardening, the apparatus comprising a housing, the housing having a backside, a front side and an inner chamber, a handle, the handle being coupled to said backside of the housing, a hose, the hose being coupled to the handle and configured to actuate release of a granular substance, a receiving clip, the receiving clip located on the handle and configured to secure the hose, a plurality of wheels, the plurality of wheels being positioned on a frame of the apparatus, a rotatable structure, the rotatable structure being coupled to an underside of the housing. The rotatable structure is configured to disperse the granular substance, a plurality of circular devices, the plurality of circular devices being removably attached to the plurality of wheels and wherein the plurality of circular devices include a plurality of projections. The plurality of projections is configured to aerate a portion of soil, wherein the apparatus for gardening is configured to simultaneously aerate and fertilize a portion of soil, and manually pushing the apparatus over the portion of soil.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a gardening apparatus, constructed and operative according to the teachings of the present disclosure.

FIG. 1 is a perspective view of the gardening apparatus during an ‘in-use’ condition, according to an embodiment of the disclosure.

FIG. 2 is a top perspective view of the gardening apparatus of FIG. 1, according to an embodiment of the present disclosure.

FIG. 3 is a rear view of the gardening apparatus of FIG. 1, according to an embodiment of the present disclosure.

FIG. 4 is a front view of the gardening apparatus of FIG. 1, according to an embodiment of the present disclosure.

FIG. 5 is a flow diagram illustrating a method of simultaneously aerating and fertilizing soil, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to gardening devices and more particularly to a gardening apparatus as used capable of simultaneously fertilizing and aerating a lawn or garden, while promoting speedy germination of plants, flowers, vegetables, and more.

Generally, the gardening apparatus may include a convenient gardening tool designed to efficiently aerate dirt and soil useful for promoting deeper root growth for lawns and yards. The tool may resemble a small version of a wheelbarrow and may be manually pushed by a user. The device may feature two tires with spikes extending from the tire surfaces for perforating the soil and aerating it when the tool is pushed. A chamber may be located atop the two wheels. The user may push the device over the soil and dirt, thereby helping to speed up the process of germination. A seed dispenser may be included below the chamber to help spread seeds evenly on the ground. The apparatus may further include a handle(s) above the chamber to assist with maneuvering the apparatus. The apparatus may be suitable for allowing a user to save time and effort because it does not require separate aeration and then seed planting. The easy push style of the system may help to achieve maximum efficiency while gardening.

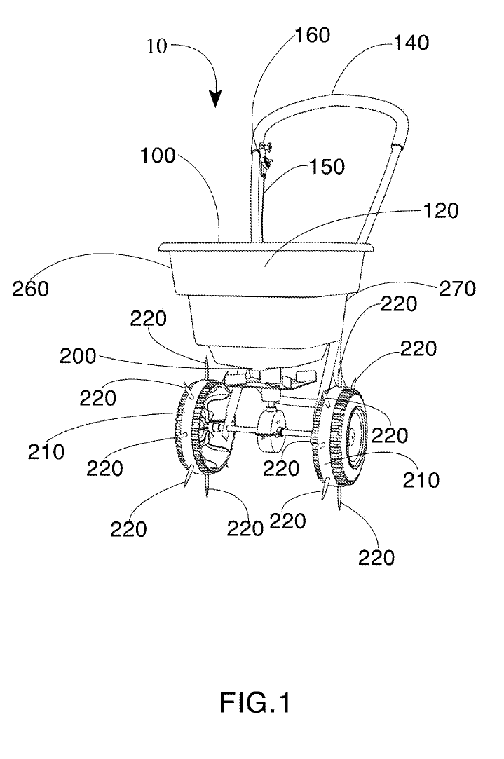

Referring now more specifically to the drawings by numerals of reference, there is shown in FIGS. 1-4, various views of an apparatus 10.

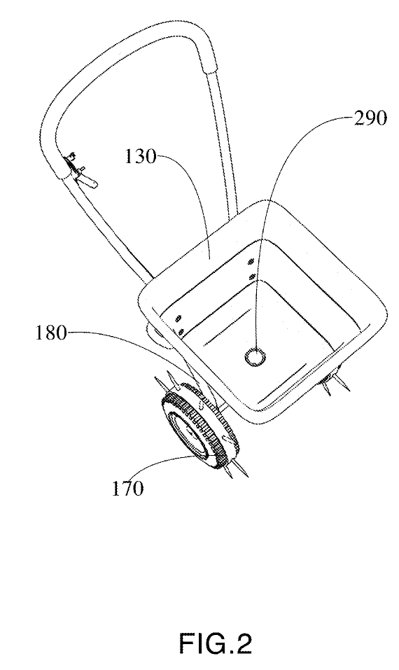

FIG. 1 shows an apparatus 10 during an ‘in-use’ condition, according to an embodiment of the present disclosure. Here, the apparatus 10 may be beneficial for use by a user to provide a gardening and agricultural tool capable of simultaneously fertilizing and aerating a lawn or garden, while promoting speedy germination of plants, flowers, vegetables, and more. As illustrated, the apparatus 10 may include a housing 100, a handle 140, a hose 150, and a receiving clip 160 located on the handle 140 and configured to secure the hose 150. The housing 100 may include a front side 120, a first portion 260, and a second portion 270. The first portion 260 and the second portion 270 may be rectangular in shape and further configured such that the first portion 260 perimeter is greater than the second portion 270 perimeter. The apparatus 10 may also include a plurality of circular devices 210, wherein the plurality of circular devices 210 may be removably attached to a plurality of wheels 170 (see FIG. 2) and include a plurality of projections 220 configured to aerate a portion of soil.

FIG. 2 shows the apparatus 10 of FIG. 1, according to an embodiment of the present disclosure. As above, the apparatus 10 may include a housing 100 (see FIG. 1) having an inner chamber 130 and an opening 290 that may be configured to allow a granular substance to pass through the inner chamber 130. The apparatus 10 may also include a plurality of wheels 170 being positioned on a frame 180. The plurality of wheels 170 may be used for allowing the plurality of circular devices 210 (see FIG. 1) to be attached thereon.

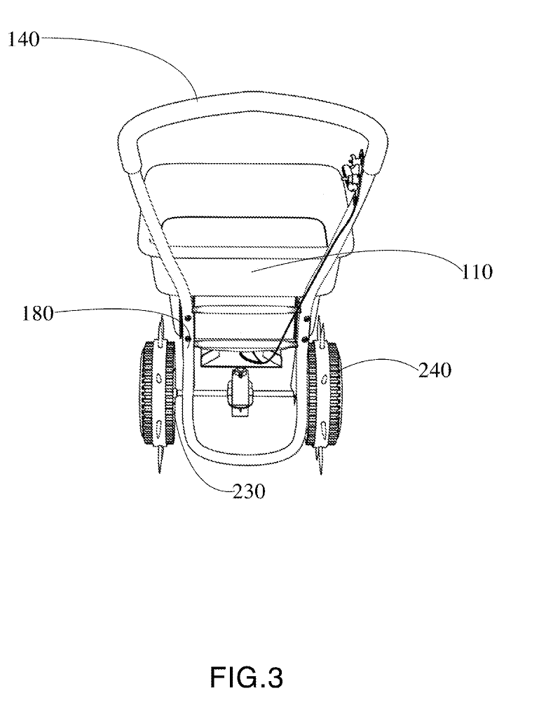

Referring now to FIG. 3 showing a rear view of the apparatus 10 of FIG. 1, according to an embodiment of the present disclosure. As above, the apparatus 10 may include a handle 140 being coupled to a backside 110 of the housing 100 (see FIG. 1). The apparatus 10 may also comprise two wheels, wherein a first of the two wheels 230 may be configured in a spaced-apart relationship from a second of the two wheels 240. The first of the two wheels 230 and the second of the two wheels 240 may be positioned on the frame 180 of the apparatus 10.

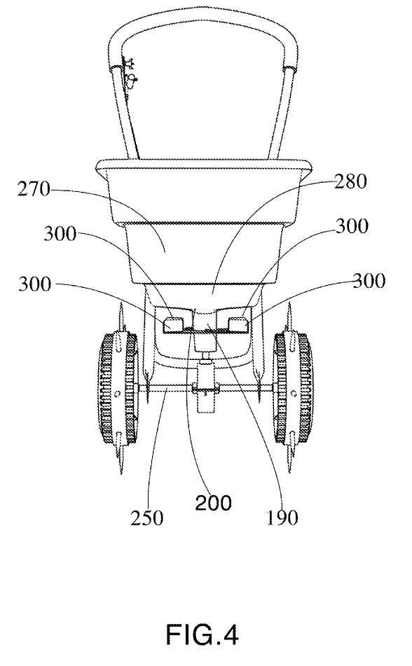

FIG. 4 is a front view of the apparatus 10 of FIG. 1, according to an embodiment of the present disclosure. Here again, the apparatus 10 may include a rotatable structure 190 having a plurality of fins 300, wherein the rotatable structure may be coupled to an underside 200 of the housing 100 (see FIG. 1). The rotatable structure 190 may be configured to disperse the granular substance from the inner chamber 130 of the housing 100 (see FIG. 1). The housing 100 (see FIG. 1) may include a second portion 270, and a third portion 280. The second portion 270 and the third portion 280 may be rectangular in shape and further configured such that the second portion 270 perimeter is greater than the third portion 280 perimeter. The apparatus 10 may also include an axle 250 to provide support to the device while in use.

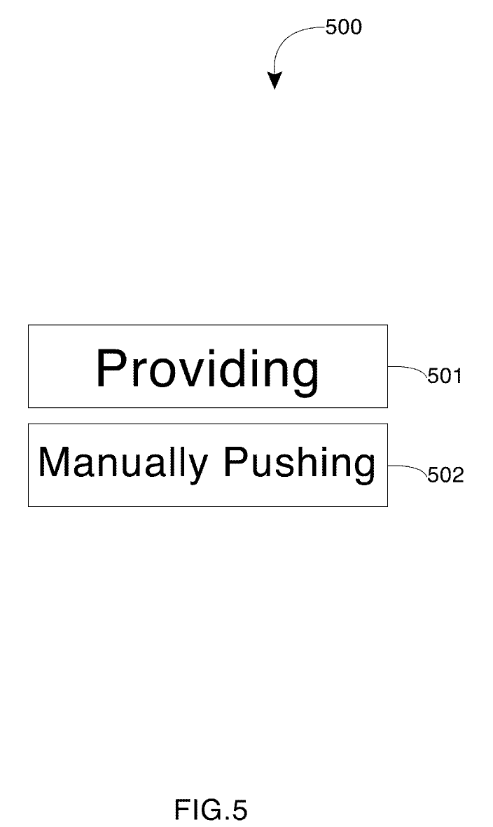

Referring now to FIG. 5, a flow diagram illustrating a method of simultaneously aerating and fertilizing soil 500, according to an embodiment of the present disclosure. In particular, the method of simultaneously aerating and fertilizing soil 500 may include one or more components or features of the apparatus 10 as described above. As illustrated, the method of simultaneously aerating and fertilizing soil 500 may include the steps of: step one 501, providing an apparatus for gardening as described previously; and step two 502, manually pushing the apparatus over the portion of soil.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the apparatus 10, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for gardening, said apparatus comprising:
a housing, said housing having a backside, a front side and an inner chamber;
a handle, said handle being coupled to said backside of said housing;
a hose, said hose being coupled to said handle and configured to actuate release of a granular substance;
a receiving clip, said receiving clip located on said handle and configured to secure said hose;
a plurality of wheels, said plurality of wheels being positioned on a frame of said apparatus;
a rotatable structure, said rotatable structure being coupled to an underside of said housing and wherein said rotatable structure is configured to disperse said granular substance;
a plurality of circular devices, said plurality of circular devices being removably attached to said plurality of wheels and wherein said plurality of circular devices include a plurality of projections;
wherein said plurality of projections is configured to aerate a portion of soil; and
wherein said apparatus for gardening is configured to simultaneously aerate and fertilize said portion of soil.

2. The apparatus of claim 1, wherein said plurality of wheels comprises two wheels.

3. The apparatus of claim 2, wherein a first of said two wheels is in a spaced-apart relationship from a second of said two wheels.

4. The apparatus of claim 3, wherein said first wheel is spaced apart from said second wheel via an axle.

5. The apparatus of claim 1, wherein said housing includes a first portion, a second portion, and a third portion.

6. The apparatus of claim 5, wherein said first portion, said second portion, and said third portion are rectangular in shape.

7. The apparatus of claim 6, wherein a first portion-perimeter is greater than a second portion-perimeter.

8. The apparatus of claim 6, wherein said second-portion-perimeter is greater than a third-portion perimeter.

9. The apparatus of claim 1, wherein said underside of said chamber has an opening.

10. The apparatus of claim 9, wherein said opening is configured to allow said granular substance to pass through said inner chamber.

11. The apparatus of claim 1, wherein said rotatable structure includes a plurality of fins.

12. The apparatus of claim 1, wherein each of said plurality of projections has a tapered end.

13. The apparatus of claim 1, wherein said plurality of projections comprises at least two projections.

14. The apparatus of claim 3, wherein one of said plurality of circular devices is removably attached to a first-outer-periphery of said first wheel.

15. The apparatus of claim 13, wherein another of said plurality of circular devices is removably attached to a second-outer-periphery of said second wheel.

16. The apparatus of claim 1, wherein said granular substance is a fertilizer.

17. An apparatus for gardening, said apparatus comprising: a housing, said housing having a backside, a front side and an inner chamber;
a handle, said handle being coupled to said backside of said housing;
a hose, said hose being coupled to said handle and configured to actuate release of a granular substance;
a receiving clip, said receiving clip located on said handle and configured to secure said hose; a plurality of wheels, said plurality of wheels being positioned on a frame of said apparatus; a rotatable structure, said rotatable structure being coupled to an underside of said housing and wherein said rotatable structure is configured to disperse said granular substance; a plurality of circular devices, said plurality of circular devices being removably attached to said plurality of wheels and wherein said plurality of circular devices include a plurality of projections; wherein said plurality of projections is configured to aerate a portion of soil; and wherein said apparatus for gardening is configured to simultaneously aerate and fertilize said portion of soil;
wherein said plurality of wheels comprises two wheels;
wherein a first of said two wheels is in a spaced-apart relationship from a second of said two wheels;
wherein said first wheel is spaced apart from said second wheel via an axle;
wherein said housing includes a first portion, a second portion, and a third portion;
wherein said first portion, said second portion, and said third portion are rectangular in shape;
wherein a first-portion-perimeter is greater than a second-portion-perimeter;
wherein said second-portion-perimeter is greater than a third-portion perimeter;
wherein said underside of said chamber has an opening;
wherein said opening is configured to allow said granular substance to pass through said inner chamber;
wherein said rotatable structure includes a plurality of fins;
wherein each of said plurality of projections has a tapered end;
wherein said plurality of projections comprises at least two projections;
wherein one of said plurality of circular devices is removably attached to a first-outer-periphery of said first wheel;
wherein another of said plurality of circular devices is removably attached to a second-outer-periphery of said second wheel; and
wherein said granular substance is a fertilizer.

18. A method of simultaneously aerating and fertilizing soil, said method comprising:
providing an apparatus for gardening, said apparatus comprising a housing, said housing having a backside, a front side and an inner chamber; a handle, said handle being coupled to said backside of said housing; a hose, said hose being coupled to said handle and configured to actuate release of a granular substance; a receiving clip, said receiving clip located on said handle and configured to secure said hose; a plurality of wheels, said plurality of wheels being positioned on a frame of said apparatus; a rotatable structure, said rotatable structure being coupled to an underside of said housing and wherein said rotatable structure is configured to disperse said granular substance; a plurality of circular devices, said plurality of circular devices being removably attached to said plurality of wheels and wherein said plurality of circular devices include a plurality of projections;
wherein said plurality of projections is configured to aerate a portion of soil; and wherein said apparatus for gardening is configured to simultaneously aerate and fertilize said portion of soil; and
manually pushing said apparatus over said portion of soil.

19. The method of claim 18, wherein manually pushing said apparatus allows for said plurality of projections to make holes in said portion of soil.

20. The method of claim 19, wherein manually pushing said apparatus allows for disbursement of said granular substance.
